(19) United States
(12) Patent Application Publication
(10) Pub. No.: US 2024/0119471 A1
(43) Pub. Date: Apr. 11, 2024

(54) METHOD, APPARATUS, DEVICE, AND STORAGE MEDIUM FOR CONVERSION EVALUATION

(71) Applicants: Beijing Youzhuju Network Technology Co., Ltd., Pinggu District (CN); Lemon Inc., Grand Cayman (KY)

(72) Inventors: Xiaowang Kong, Beijing (CN); Shu Chen, Beijing (CN); Zhibin Wu, Beijing (CN); Zhe Wang, Los Angeles, CA (US); Haiqian HE, Singapore (SG)

(21) Appl. No.: 18/472,624

(22) Filed: Sep. 22, 2023

(30) Foreign Application Priority Data
Sep. 30, 2022 (CN) 202211216780.4

(51) Int. Cl. G06Q 30/0202; G06Q 30/0201

(52) U.S. Cl. CPC G06Q 30/0202; G06Q 30/0206

(57) ABSTRACT

According to the embodiments of the present disclosure, a method for conversion evaluation comprises: extracting a resource feature from resource-related data of a target resource; extracting an audience feature of the target audience group from audience-related data of a target audience group of the target resource, the target audience group being to be distributed with a recommended content item related to the target resource; and determining, based on the resource feature and the audience feature, a target predicted conversion rate for the target resource through a predetermined association between resource features, audience features and predicted conversion rates, the target predicted conversion rate indicating a predicted probability of the target audience group performing a conversion for the target resource. According to the scheme, the accuracy of the conversion rate evaluation may be improved, thereby improving distribution effect of the recommended content item for a resource.

### CROSS-REFERENCE TO RELATED APPLICATIONS

The present application claims priority to Chinese Patent Application No. 202211216780.4, titled “METHOD, APPARATUS, DEVICE AND MEDIUM FOR CONVERSION EVALUATION,” filed on Sep. 30, 2022, the contents of which are hereby incorporated by reference in its entirety.

### FIELD

Embodiments of the present disclosure generally relate to computer technology, and in particular to a method, an apparatus, a device, and a computer-readable storage medium for conversion evaluation.

### BACKGROUND

The Internet provides access to various resources. For example, various applications, products, audio and video content, and the like may be accessed through the Internet. With a rapid growth of quantity and variety, it is very difficult for the audience of resources to find a resource they are interested in from a large number of resources. For resource providers, they also expect their resources to receive attention of the target audience. In view of this, a recommendation system is applied to recommend resources that meet user needs to the audience group. When providing recommended content related to a specific resource, it is usually expected that the audience may perform a specific conversion event, such as downloading, registering, adding to a shopping cart, purchasing, or other resource demand behaviors. The evaluation of conversion may affect the placement, payment, or the like of resource recommendations, and therefore it is expected to achieve accurate conversion evaluation.

### SUMMARY

In a first aspect of the present disclosure, a method of conversion evaluation is provided. The method comprises: extracting a resource feature from resource-related data of a target resource; extracting an audience feature of a target audience group from audience-related data of the target audience group of the target resource, the target audience group being to be distributed with a recommended content item related to the target resource; and determining, based on the resource feature and the audience feature, a target predicted conversion rate for the target resource through a predetermined association between resource features, audience features and predicted conversion rates, the target predicted conversion rate indicating a predicted probability of the target audience group performing a conversion for the target resource.

In a second aspect of the present disclosure, an apparatus for conversion evaluation is provided. The apparatus comprises: a resource feature extracting module configured to extract a resource feature from resource-related data of a target resource; an audience feature extracting module configured to extract an audience feature of a target audience group from audience-related data of the target audience group of the target resource, the target audience group being to be distributed with a recommended content item related to the target resource; and a conversion rate determining module configured to determine, based on the resource feature and the audience feature, a target predicted conversion rate for the target resource through a predetermined association between resource features, audience features and predicted conversion rates, the target predicted conversion rate indicating a predicted probability of the target audience group performing a conversion for the target resource.

In a third aspect of the present disclosure, an electronic device is provided. The device comprises at least one processing unit; and at least one memory coupled to the at least one processing unit and storing instructions executable by the at least one processing unit, the instructions, when executed by the at least one processing unit, causing the device to perform the method of the first aspect.

In a fourth aspect of the present disclosure, a computer-readable storage medium is provided. The medium has a computer program stored thereon which, when executed by a processor, performs the method according to the first aspect.

It would be appreciated that the content described in the Summary section of the present invention is neither intended to identify key or essential features of the embodiments of the present disclosure, nor is it intended to limit the scope of the present disclosure. Other features of the present disclosure will be readily envisaged through the following description.

### BRIEF DESCRIPTION OF THE DRAWINGS

The above and other features, advantages and aspects of the embodiments of the present disclosure will become more apparent in combination with the accompanying drawings and with reference to the following detailed description. In the drawings, the same or similar reference symbols refer to the same or similar elements, where:

FIG. 1 illustrates a schematic diagram of an example environment in which the embodiments of the present disclosure may be implemented;

FIG. 2 illustrates a schematic block diagram of a content management system according to some embodiments of the present disclosure;

FIG. 3 illustrates a schematic diagram of a training process of a conversion rate estimation model according to some embodiments of the present disclosure;

FIG. 4 illustrates a model architecture and a training architecture of the conversion rate estimation model according to some embodiments of the present disclosure;

FIG. 5 illustrates a schematic block diagram of an example of a strategy maker according to some embodiments of the present disclosure;

FIG. 6 illustrates a flowchart of a conversion evaluation process according to some embodiments of the present disclosure;

FIG. 7 illustrates a block diagram of an apparatus for conversion evaluation according to some embodiments of the present disclosure; and

FIG. 8 illustrates an electronic device in which one or more embodiments of the present disclosure may be implemented.

### DETAILED DESCRIPTION

The embodiments of the present disclosure will be described in more detail below with reference to the accompanying drawings. Although some embodiments of the present disclosure are shown in the drawings, it would be appreciated that the present disclosure may be implemented in various forms and should not be interpreted as limited to the embodiments described herein. On the contrary, these embodiments are provided for a more thorough and complete understanding of the present disclosure. It would be appreciated that the drawings and embodiments of the present disclosure are only for illustrative purposes and are not intended to limit the scope of protection of the present disclosure.

In the description of the embodiments of the present disclosure, the term “including” and similar terms should be understood as open inclusion, that is, “including but not limited to”. The term “based on” should be understood as “at least partially based on”. The term “one embodiment” or “the embodiment” should be understood as “at least one embodiment”. The term “some embodiments” should be understood as “at least some embodiments”. Other explicit and implicit definitions may also be included below.

It is understandable that the data involved in this technical proposal (including but not limited to the data itself, data acquisition or use) shall comply with the requirements of corresponding laws, regulations and relevant provisions.

It is understandable that before using the technical solution disclosed in each embodiment of the present disclosure, users should be informed of the type, the scope of use, the use scenario, etc. of the personal information involved in the present disclosure in an appropriate manner in accordance with relevant laws and regulations, and the user's authorization should be obtained.

For example, in response to receiving an active request from a user, a prompt message is sent to the user to explicitly prompt the user that the operation requested operation by the user will need to obtain and use the user's personal information. Thus, users may select whether to provide personal information to the software or the hardware such as an electronic device, an application, a server or a storage medium that perform the operation of the technical solution of the present disclosure according to the prompt information.

As an optional but non-restrictive implementation method, in response to receiving the user's active request, the method of sending prompt information to the user may be, for example, a pop-up window in which prompt information may be presented in text. In addition, pop-up windows may also contain selection controls for users to choose “agree” or “disagree” to provide personal information to electronic devices.

It may be understood that the above notification and acquisition of user authorization process are only schematic and do not limit the implementation methods of the present disclosure. Other methods that meet relevant laws and regulations may also be applied to the implementation of the present disclosure.

As used in herein, the term “model” may learn a correlation between a corresponding input and output from training data, so that a corresponding output may be generated for a given input after a training is completed. Model generation may be based on machine learning technology. Deep learning is a machine learning algorithm that uses multiple layers of processing units to process input and provide corresponding output. A neural network model is an example of a deep learning-based model. In this article, a “model” may also be referred to as a “machine learning model”, a “learning model”, a “machine learning network”, or a “learning network”, and these terms are used interchangeably in this article.

A “neural network” is a machine learning network based on deep learning. The neural network may process input and provide corresponding output, which typically including input and output layers, and one or more hidden layers between the input and output layers. A neural network used in a deep learning application typically includes many hidden layers to increase the depth of the network. Respective layers of a neural network are sequentially connected, so that output of a previous layer is provided as input to a subsequent layer. The input layer receives input of the neural network, while output of the output layer serves as final output of the neural network. Each layer of the neural network includes one or more nodes (also referred to as processing nodes or neurons), and each node processes input from a previous layer.

In general, machine learning may roughly include three stages, namely a training stage, a testing stage, and an application stage (also referred to as an inference stage). During the training stage, a given model may be trained using a large amount of training data, iteratively updated parameter values until the model may obtain consistent inference that meets an expected goal from the training data. Through the training, the model may be considered to be able to learn the correlation between input and output (also referred to as input to output mapping) from the training data. The parameter values of the trained model are determined. In the testing stage, test input is applied to the trained model to test whether the model may provide correct output, thereby determining the performance of the model. In the application stage, the trained model may be used to process actual input and determine corresponding output based on the parameter values obtained through training.

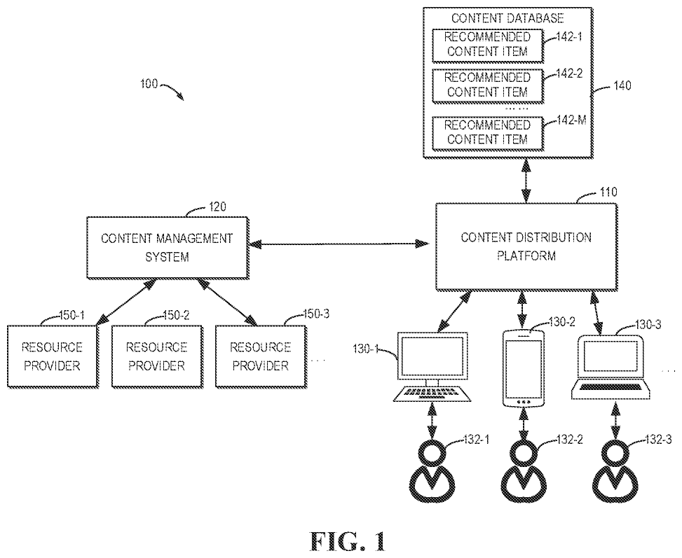

FIG. 1 illustrates a schematic diagram of an example environment 100 in which the embodiments of the present disclosure may be implemented. One or more content providers may use a content management system 120 to manage content on a content distribution platform 110. One or more terminal devices 130-1, 130-2, 130-3, or the like (collectively or individually referred to as a terminal device 130 for convenience of discussion) are associated with the content distribution platform 110 and may access various types of content provided on the content distribution platform 110 based on corresponding audiences 132-1, 132-2, 132-3, or the like (collectively or individually referred to as audiences 132 for convenience of discussion). As an example, the content distribution platform 110 may be an application, a website, a webpage, and other accessible platforms. The terminal device 130 may have an application installed thereon for accessing the content distribution platform 110, or may access the content distribution platform 110 in an appropriate manner.

The content management system 120 may be configured to provide, based on a corresponding strategy, one or more specific recommended content items related to one or more resources (for example, provide to the terminal device 130) to an audience group. For example, the recommended content items may include one or more recommended content items 142-1, 142-2, . . . , 142-M in a content database 140 (collectively or individually referred to as a recommended content item 142 for convenience of discussion).

Herein, the resources may include, for example, various types of promotable objects, such as an application, a physical product, a virtual product, audio and video content, or the like. In this article, the recommended content item refers to content presented for recommending a corresponding resource. An example of the recommended content item may include an advertisement. Herein, the audience group may include one or more audience members, such as the audiences 132. The audience member may be any potential consumer of a resource, such as a user, a group, an organization, an entity, or the like.

In some embodiments, a plurality of different recommended content items may be provided for a certain resource. The content management system 120 may distribute corresponding recommended content items on the content distribution platform 110 based on a request of resource providers 150-1, 150-2, 150-3, or the like (collectively or individually referred to as a resource provider 150 for convenience of discussion).

In some embodiments, the content management system 120 may distribute the recommended content item 142 to the corresponding audiences 132 on the content distribution platform 110 at least based on requests of respective resource providers 150-1, 150-2, 150-3, or the like (collectively or individually referred to as resource providers 150 for convenience of discussion). In an advertising placement scenario, the resource provider 150 is sometimes referred to as an advertiser. In some embodiments, the resource provider may also pay the content provider based on presentation of the recommended content item and a subsequent conversion and so on.

In some embodiments, the content management system 120 may further select a recommended content item for presenting to a specific terminal device 130 in a content distribution opportunity (for example, at a specific time and a specific location) of the content distribution platform 110 based on a bidding result. For example, the content management system 120 may receive bids from the resource provider 150 and allocate a content distribution opportunity to a highest bidder. The bid may be the cost that the resource provider 150 is willing to pay for presenting their recommended content item using the content distribution opportunity. For example, the bid may indicate the cost that the resource provider is willing to pay for the presentation of the recommended content item, referred to as eCPM (Expected Cost Per Mile). Alternatively, the bid may specify how much the resource provider is willing to pay for interactions between the audience group and the recommended content item (for example, clicking or hovering a cursor over it) or the “conversion” of interactions between the audience group and the recommended content item.

When the audience group completes a demand behavior related to the recommended content item, a conversion occurs. The event that constitute the conversion may vary depending on different situations and may be determined in various ways. For example, the conversion may occur when the recommended content item is clicked. The conversion may also be defined by the resource provider as any measurable/observable event, such as a download behavior, navigating at least to a given depth of a website or an application, viewing at least a certain number of webpages, spending at least a predetermined amount of time on a website, a webpage, or an application, registering an account on a website or an application, adding a product to a shopping cart, completing product purchase, or the like. Other events that constitute the conversion may also be used.

In the environment 100, the terminal device 130 may be any type of mobile terminal, fixed terminal or portable terminal, including a mobile phone, a desktop computer, a laptop computer, a notebook computer, a netbook computer, a tablet computer, a media computer, a multimedia tablet, a personal communication system (PCS) device, a personal navigation device, a personal digital assistant (PDA), an audio/video player, a digital camera/video camera, a positioning device, a television receiver, a radio receiver, an e-book device, a gaming device, or any combination of the foregoing, including accessories and peripherals of these devices or any combination thereof. In some embodiments, the terminal device 110 may also support any type of user-specific interface (such as a “wearable” circuit, or the like). The content management system 120 may be, for example, various types of computing systems/servers capable of providing computing capability, including but not limited to mainframes, edge computing nodes, computing devices in cloud environments, and the like.

It should be understood that the structure and function of each element in the environment 100 are only described for purpose of illustration, without suggesting any limitations to the scope of the present disclosure.

In a scenario of recommended content distribution for resources, it is usually necessary to measure a conversion indicator related to the recommended content distribution, including estimating a probability of a conversion event occurring to a user. Such a conversion probability is also referred to as a conversion rate (CVR). The conversion rate may affect the formulation of many subsequent strategies.

Currently, a conversion rate estimation model is generally trained to evaluate the conversion rate. Many conversion rate models typically evaluate conversion rates at a level of audience and recommended content item, to attribute a conversion performed by an audience group to a specific recommended content item. Therefore, these models are configured to evaluate a probability that a conversion occurs when a user clicks on a specific recommended content item. The conversion rate estimation model is also optimized constantly and iteratively, but its optimization direction is mainly about collecting more model input samples to enrich audience features and designing more complex model structure to model audience preferences for recommended content items (for example, an advertisement).

However, in a recommendation scenario, compared to the number of presented recommended content items, conversions occur less frequently, especially occurrences of some deep conversion events are even less, resulting in insufficient training data for the model, insufficient learning of the model, and low prediction accuracy. Inaccurate conversion rate estimation may lead to many issues such as billing methods for recommended content being inaccurate and content recommendation strategies being inaccurate. In addition, because the probability that a conversion event occurs when a user clicks on a specific recommended content item is required to be evaluated, data related to the recommended content item and data related to the audience are less when a certain recommended content item is not distributed or during an early stage of distribution (that is, a cold start stage), which further exacerbates the problem of inaccurate model estimation. On the other hand, although designing a complex model may improve the performance, running the model may bring excessive resource overhead and time consumption, making it difficult to balance the gains and overhead brought by the complex model.

In the embodiments of the present disclosure, a more generalized conversion evaluation scheme is proposed. Unlike a conversion evaluation scheme that rely solely on attribution data, in the present disclosure, when performing the conversion evaluation, both the attribution data and non-attribution data may be used to model a conversion evaluation process. For convenience of understanding, the attribution data and the non-attribution data are defined first.

Specifically, the conversion for a certain resource may occur not only on the current content distribution platform, but also on other platforms outside of the current content distribution platform, such as a platform managed by the resource provider, other content distribution platforms or third-party platforms. For example, a supplier of an application may distribute advertisements of the application to a plurality of different platforms. For a specific advertisement on a certain platform, the attribution data refers to a conversion (assuming it is an application download) that occurs when a user clicks on the specific advertisement on the platform; the non-attribution data refers to a conversion that cannot be attributed to the specific advertisement, including a conversion attributed to an advertisement on other content distribution platforms or a conversion executed by a user spontaneously. In comparison, the amount of non-attribution data is often greater than the amount of attribution data.

According to the present disclosure, evaluating the probability of a user causing a conversion event for a resource at a user level and a resource level is proposed. Such a conversion evaluation is determined based on audience-related data and resource-related data. By extracting an audience feature and a resource feature, preferences of the audience group for resources may be constructed, especially the preference of the audience group for resources that is prone to conversion. This may improve the accuracy of the conversion rate evaluation, thereby improving the distribution effect of the recommended content item for a resource.

The following will continue to refer to the accompanying drawings to describe some example embodiments of the present disclosure.

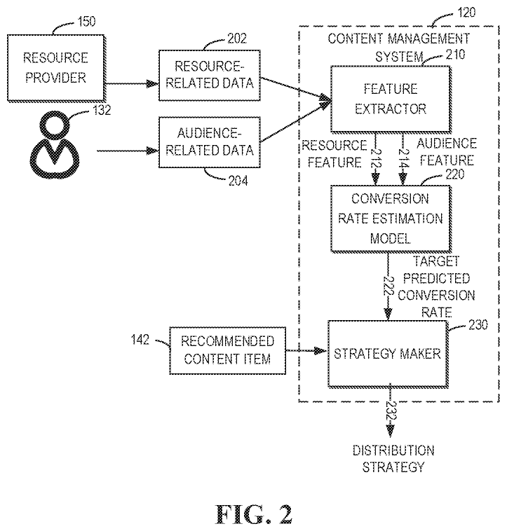

FIG. 2 illustrates a schematic block diagram of a content management system according to some embodiments of the present disclosure. Some embodiments of the present disclosure may be implemented in the content management system. For convenience of discussion, reference will be made to the content management system 120 in the environment 100 of FIG. 1 for description.

As shown in FIG. 2, the content management system 120 includes a feature extractor 210 and a conversion rate estimation model 220. In some embodiments described below, the content management system 120 may also include a strategy maker 230.

The feature extractor 210 is configured to obtain resource-related data 202 of a target resource and audience-related data 204 of a target audience group of the target resource. The target resource may be a resource provided by a specific resource provider 150, such as an application, a physical product, a virtual product, or the like. The target audience refers to an audience group to which a recommended content item related to the target resource is expected to be distributed, and the audience group may include one or more audience members.

The feature extractor 210 is configured to extract a resource feature 212 from the resource-related data 202 and an audience feature 214 from the audience-related data 204. The resource feature 212 is used to characterize relevant features of the target resource, and the audience feature 214 is used to characterize relevant features of the target audience group. The resource feature 212 and the audience feature 214 may be represented in a form of multidimensional vector.

In some embodiments, the resource-related data 202 may include one or more aspects of attribute information related to the target resource, such as a resource type, supplier, industry information, appearance information, price, comment information, rating information, and so on. The audience-related data 204 may include one or more aspects of attribute information related to the target audience group, such as demography-related information of the target audience group, historical conversion behaviors for various resources, historical operations performed on the content distribution platform (for example, a browsing behavior), and other available data upon authorization of the target audience group.

In some embodiments, the resource-related data 202 and the audience-related data 204 may be provided to the content management system 120 based on the authorization of the resource provider 150 and/or the target audience group (for example, one or more audiences 132). As an example, the target audience group may authorize the resource provider 150 to obtain the audience-related data 204 by the resource provider 150. The content management system 120 may receive the resource-related data 202 and the audience-related data 204 from the resource provider 150. In other examples, the content management system 120 may obtain required data from the resource provider 150 and other data sources authorized by the target audience group, respectively.

The resource feature 212 and the audience feature 214 are used to determine a target predicted conversion rate 222 for the target resource. The target predicted conversion rate 222 indicates a predicted probability of the target audience group performing a conversion for the target resource. Specifically, the target predicted conversion rate corresponding to the resource feature 212 and the audience feature 214 is determined through a predetermined association between resource features, audience features and predicted conversion rates.

The “predetermined association” between the resource features, the audience features and the predicted conversion rates is used to characterize a mapping between the resource features, the audience features and the conversion rates for resources. The association models preferences of the audience group for the resources to evaluate whether the target audience group may undergo a conversion for the target resource.

In some embodiments, the “predetermined association” between the resource features, the audience features and the predicted conversion rates may be represented in a form of machine learning model, which may be referred to as a conversion rate estimation model, for example, the conversion rate estimation model 220 as shown in FIG. 2. The model input of the conversion rate estimation model 220 includes the resource feature of a certain resource and the audience feature of the audience group of the resource, and the mode output includes the predicted conversion rate for the resource, to indicate the predicted probability of the audience group performing the conversion for the resource.

Unlike modeling audience preferences for specific recommended content items, in the embodiments of the present disclosure, a more generalized approach is used to model preferences of the audience group for resources at the level of the target audience group and the target resource to be recommended, to achieve conversion evaluation for the target resource. According to such a modeling method, the association may be determined from various conversion data (including the attribution data and the non-attribution data) of a specific resource without being limited to conversion data that is attributed to a specific recommended content item. In this way, more conversion data may be used to model more accurate associations (for example, the conversion rate estimation model), thereby the associations may be utilized to perform more accurate conversion evaluation.

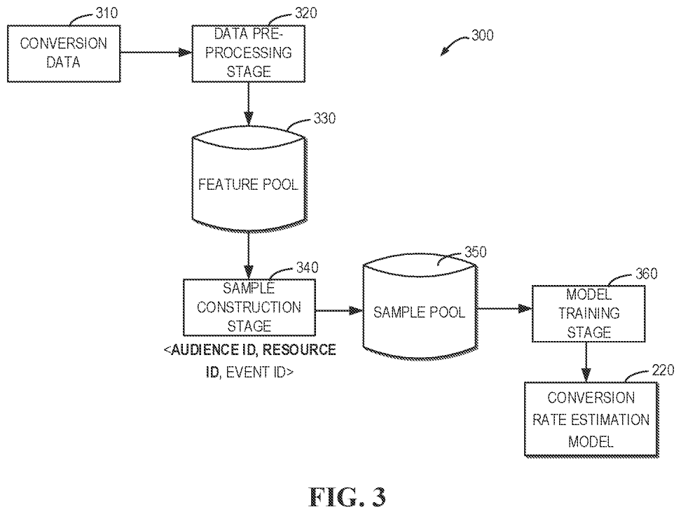

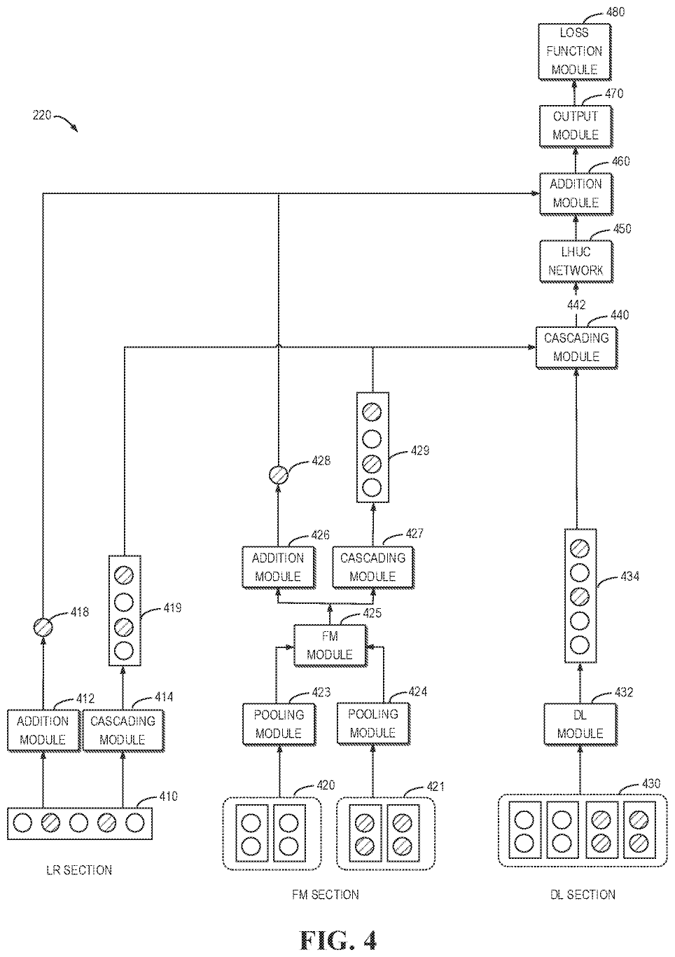

The predetermined association between the resource features, the audience features and the predicted conversion rates, or the conversion rate estimation model 220 may be determined through a training process. The training process of the conversion rate estimation model will be described in the following in more detail with reference to FIG. 3 and FIG. 4.

The target predicted conversion rate 222 may be provided to the strategy maker 230, which is configured to perform the formulation of various strategy related to the recommended content item 142 of the target resource. In some embodiments, the strategy maker 230 is configured to determine, based on the target predicted conversion rate, a distribution strategy of the recommended content item 142 related to the target resource among the target audience group. In some embodiments, the distribution strategy may indicate one or more parameters related to the distribution of the recommended content item 142, including in which distribution opportunity/opportunities the recommended content item is distributed to the target audience group, and/or to which audience members in the target audience group the recommended content item is distributed. The distribution strategy may also indicate other parameters related to the distribution of the recommended content item 142, such as cost data of the distribution, for example, cost of the conversion of the recommended content item 142, or the like. These specific parameters are associated with a specific management strategy of the content distribution platform. The following will describe some example embodiments related to the formulation of the distribution strategy.

FIG. 3 illustrates a schematic diagram of a training process 300 of the conversion rate estimation model 220 according to some embodiments of the present disclosure. The training process 300 includes a data pre-processing stage 320, a sample construction stage 340, and a model training stage 360.

The data pre-processing stage 320 obtains conversion data 310 for one or more sample resources. The sample resource may be any type of resource, or a specific type of resource (for example, both are applications). The conversion data 310 indicates the resource-related data of the sample resource, and the audience-related data of a sample audience group who has performed a conversion for the sample resource. That is to say, the recommended content item related to the sample resource may have been distributed to these sample audience groups, and it may be collected that these sample audience groups have performed conversions.

The conversion data 310 may include multi-platform conversion data for the sample resource, without the need to attribute it to a specific recommended content item of the sample resource. In some embodiments, the conversion data 310 may include conversion data of the audience group attributed to one or more recommended content items that are distributed on the content distribution platform 110, for example, an application download behavior performed by the audience group after clicking on an advertisement on the content distribution platform 110. The conversion data 310 may further include conversion data attributed to a recommended content item distributed on other content placement platforms, and conversion data of a conversion performed spontaneously by a user. In some embodiments, the conversion data 310 may be obtained based on the authorization of the resource provider 150 of the sample resource and/or the authorization of the sample audience group. In some embodiments, the conversion data 310 may be obtained from the resource provider 150.

In the data pre-processing stage 320, a resource feature of the sample resource and an audience feature of the sample audience group for the sample resource are extracted from the conversion data 310, and these features are stored in a resource pool 330. The specific feature that is extracted may be determined based on the design of the model input of the conversion rate estimation model 220.

In the sample construction stage 340, training samples required for training the conversion rate estimation model 220 is constructed from features included in a feature pool 330. In some embodiments, the training samples include a positive training sample, which includes a resource feature of a specific sample resource from a feature pool and an audience feature of a first sample audience group for the sample resource. The positive training sample indicates that a sample audience group corresponding to the audience feature has performed a conversion for the sample resource, which means that the predicted sample conversion rate of the sample audience group on the sample resource is 100% or close to 100%. The positive training sample may be constructed from the resource feature extracted from the conversion data 310 and the corresponding audience feature. The model may learn which audience groups may undergo conversions on which resources from the positive training sample.

In some embodiments, model training further requires a negative training sample to enable the model to learn which audience groups may not undergo conversions on which resources. Because all features provided by the conversion data 310 are related to conversions that have occurred, in some embodiments, a negative training sample may be constructed based on a method of audience random sampling. Specifically, the sample features from the positive training sample may be kept unchanged, and the audience feature may be randomly selected from the feature pool 330 to form the negative training sample. The randomly selected audience feature has a high probability of involving the audience group (sometimes referred to as a “second sample audience group” in this article) that has not undergone a conversion for the sample resource. In other embodiments, the negative training sample may also be constructed through other methods, and the embodiments of the present disclosure are not limited in this regard.

In the sample construction stage 340, a certain number of positive and negative training samples may be constructed according to the needs of model training, and a proportion between positive and negative training samples may be determined.

In some embodiments, the training sample may be identified by a corresponding audience identifier (ID) and a resource ID to indicate the audience feature and the resource feature included in the training sample, respectively. In some embodiments, the positive training sample may further be identified by an event identifier (ID) (also known as an event label) to indicate an event type of a conversion of the sample audience group in the positive training sample. During the conversion, events corresponding to various demand behaviors of the audience group on resources may be defined as conversions, for example, downloading, registering, adding to a shopping cart, purchasing, or other resource demand behaviors.

In the training samples, the occurrence of different events may characterize a probability of a conversion in various degrees. For example, a deeper level conversion event (for example, downloading or purchasing) may allow the model to better determine a preference of the audience group for resources, while a lower level conversion event (for example, adding to a shopping cart or visiting a webpage) may allow the model to learn preferences of the audience group for resources partially. Therefore, the training of the model varies for different types of events. In some embodiments, the conversion rate estimation model 220 is expected to learn the impact of different interaction behaviors on conversion occurrences differentially. A training target of the conversion rate estimation model 220 is configured to update model parameter values of the conversion rate estimation model based at least on the event type.

The samples constructed in the sample construction stage 340 are stored in a sample pool 350. In the model training stage 360, the conversion rate estimation model 220 is trained using the positive training sample and the negative training sample in the sample pool 350.

In some embodiments, the conversion rate estimation model 220 may be constructed as a model suitable for receiving the resource feature and the audience feature as model input, processing the model input, and providing the predicted conversion rate as model output.

Considering that the conversion rate estimation model 220 aims to explore the preference of the audience group for resources and accurately estimate the probability of a conversion occurrence, in some embodiments, during the conversion estimation process, the conversion rate estimation model 220 may be constructed to determine a feature crossing result of the input resource feature and the audience feature, and output the predicted conversion rate based on the feature crossing result. The feature cross refers to the combination of two or more features for realizing a nonlinear conversion of sample space to increase nonlinear capability of the model. The association between the audience group and resources may be better explored by the crossing feature.

Various model training techniques may be utilized to train the model. During the training, the parameter values of the model may be updated by constructing a training target (for example, a loss function based training target) and using an algorithm such as a stochastic gradient descent algorithm or the like. The model parameter values may be continuously updated until the training target is reached, for example, minimizing the loss function or reducing the loss function to an expected value, or the number of update iterations reaching a predetermined number, or the like.

Due to being not limited to attribution of a specific recommended content item, more attribution and non-attribution conversion data may be obtained to characterize the sample resource and the sample audience group. The conversion rate estimation model trained based on these conversion data may learn the conversion posterior of the audience group for resources, better generalize to other resources and audience groups, better determine a conversion preference of the audience group for resources, thereby accurately estimating the possibility of a potential conversion of the audience group for resources. In some embodiments, the conversion rate estimation model trained based on the attribution and non-attribution data may also be referred to as a non-attribution perturbation model.

FIG. 4 illustrates a model architecture and a training architecture of the conversion rate estimation model 220 according to some embodiments of the present disclosure. In an example of FIG. 4, the conversion rate estimation model 220 is constructed based on a wide and deep (Wide & Deep) architecture to explore resource features as the model input and learn a multi-level feature cross of features. During the training, the parameter values of the conversion rate estimation model 220 may further be individually adjusted based on a Learn Hidden Unit Contribution (LHUC) network for different types of conversion events.

Specifically, as shown in FIG. 4, the conversion rate prediction model 220 includes a Logistic Regression (LR) section, a Factorization Machines (FM) section, and a Deep Learning (DL) section.

In the LR section, input 410 may include a combination of resource features and audience features. The LR section may include an addition module 412 and a cascading module 414, which perform feature addition and feature cascading on the features in the input 410, respectively, to obtain an addition feature 418 and cascading features 419.

The FM section is configured to perform automatic crossing between resource features 420 and audience features 421. The FM section includes a pooling module 423 and a pooling module 424, which are configured to perform feature pooling on the resource features 420 and the audience features 421, respectively, to increase or decrease a feature dimension to a specific dimension. An FM module 425 may be configured to learn a weight of a crossing feature through an inner product of feature vectors. In some embodiments, the feature cross used in the FM module 425 may be manually designed, such as a second-order cross (that is, a pairwise cross). The feature crossing result output by the FM module 425 is provided to an addition module 426 and a cascading module 427, respectively, to perform feature summing and feature cascading to obtain an addition feature 428 and cascading features 429.

In the DL section, a combination of resource features and audience features 430 is provided to a DL module 432, which is configured to automatically learn how resource features and audience features perform the feature cross based on deep learning technology, resulting in crossing features 434.

The conversion rate estimation model 220 may further include a cascading module 440 for cascading the features 419, 429, and 434 from respective sections to obtain cascading features 442. The cascading features 442 are provided to an LHUC network 450.

The LHUC network 450, also referred to as an LHUC tower, is configured to determine updates to the parameter values of the conversion rate estimation model 220 based on the event type indicated by the event label (for example, the event ID) of the training samples corresponding to the current model input. The LHUC network 450 may control the parameter values of the conversion rate estimation model 220 to be adjusted in different ways for different types of conversion events. In some examples, for a deeper level conversion, an adjustment stride of the parameter values of the conversion rate estimation model 220 may be determined to be larger, while for a lower level conversion, the adjustment stride of the parameter values of the model may be determined to be smaller. In this way, the conversion rate estimation model 220 may be converged faster and learned to evaluate a deeper level conversion.

An addition module 460 is configured to aggregate the addition feature 418, the addition feature 428, and features processed by the LHUC network 450, and determine the model output by an output module 470 based on the result of the addition. A loss function module 480 is configured to determine a loss value of the loss function based on a difference between currently given model output and expected model output of the training sample (that is, the predicted conversion rate), and update the parameter values of the model based on the loss value.

The training process of the model is completed by iteratively updating the model parameter values until the training target is reached. It is to be noted that in FIG. 4, the LHUC network 450 and the loss function module 480 are modules set for the purpose of model training, and will not be needed in the model application stage after training.

It should be understood that the model architecture and its training architecture of the conversion rate estimation model shown in FIG. 4 are only an example provided for explanatory purposes. According to an actual situation, other model architectures may be designed (for example, other models based on deep learning or neural networks), and other model training techniques may be utilized (for example, the LHUC network may not be used). The embodiments of the present disclosure are not limited in this regard. For example, the FM section may be replaced by a Field-aware Factorization Machines (FFM) based structure, or the like.

After the model training, the trained conversion rate estimation model 220 may be provided to the content management system 120 to perform a conversion rate estimation for the target resource and the target audience group.

As mentioned above, the target predicted conversion rate 222 output by the conversion rate estimation model 220 for the target resource and the target audience group may be provided to the strategy maker to determine the distribution strategy.

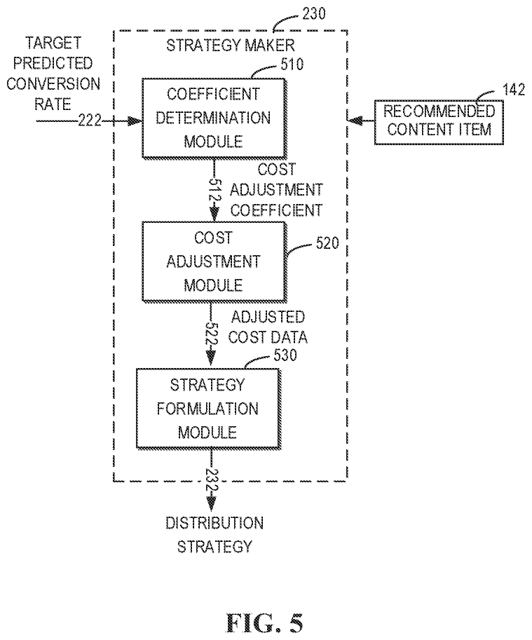

FIG. 5 illustrates a schematic block diagram of an example of the strategy maker 230 according to some embodiments of the present disclosure. It is assumed that the strategy maker 230 will determine the distribution strategy of the recommended content item 142 (for example, a specific advertisement) related to the target resource among the target audience group.

In some embodiments, in the strategy maker 230, the target predicted conversion rate 222 is used to adjust (or perturb) cost data for the recommended content item 142, thereby affecting the distribution strategy of the recommended content item 142.

For example, in a distribution process of recommended content items based on bidding, specific cost data for the recommended content item 142 may be given. The cost data may indicate the cost that the resource provider 150 is willing to pay for presenting a recommended content item using a content distribution opportunity. For example, bidding may indicate the cost that the resource provider is willing to pay for the presentation of a recommended content item, which may affect an evaluation of eCPM.

From the perspective of the resource provider, eCPM is an expected revenue for thousand times of display. The content distribution platform relies on content distribution opportunities to gain revenue, therefore the distribution opportunities of the content delivery platform are prone to content distribution plans with higher and more stable eCPM, thereby achieving maximum expected revenue. The expected revenue is based on a statistical theory, which is mainly related to bidding willingness of the resource provider and quality of the recommended content item (for example, a possibility of clicking and conversion). The calculation equation is: eCPM=bid (Pbid)*estimated click-through rate (eCTR)*estimated conversion rate (eCVR)*1000.

From the perspective of the resource provider, eCPM is estimated cost of thousand times of display. The higher the eCPM, the more competitive the recommendation and the greater the number of obtained conversions.

It may be seen that more reasonable cost data and more accurate eCPM may measure expected distribution effect better, thereby optimizing distribution effect of the recommended content item.

In the strategy formulation embodiment based on cost adjustment shown in FIG. 5, the strategy maker 230 includes a coefficient determination module 510, a cost adjustment module 520, and a strategy formulation module 530. The coefficient determination module 510 is configured to determine a cost adjustment coefficient 512 for the recommended content item 142 based on the target predicted conversion rate 222.

The target predicted conversion rate 222 indicates a predicted conversion probability of the target audience group that is currently expected to be distributed with the recommended content item 142 for the target resource. In some embodiments, in order to further reduce the instantaneous conversion error of the conversion rate estimation model 220, the conversion evaluation result may be optimized based on a historical conversion situation.

In some embodiments, the coefficient determination module 510 may perform historical conversion rate accumulation based on sliding windows at the granularity of the recommended content item. Specifically, the coefficient determination module 510 may call the conversion rate estimation model 220 to determine a historical predicted conversion rate for the target resource, and the historical predicted conversion rate indicates a predicted probability of a historical audience group of the target resource performing a conversion for the target resource. Here, the historical audience group is provided with the recommended content item related to the target resource within a historical time period. The historical time period may include a predetermined time window computed forward from the current time, which may be an hour level time window or a window with other time granularity.

When determining the historical predicted conversion rate, the audience-related data of one or more historical audience groups to which the recommended content item is distributed within the historical time period may be obtained; one or more corresponding audience features are extracted; and the target resource corresponding to each audience feature and resource feature is applied as input of the conversion rate estimation model 220; and the historical predicted conversion rate provided by the conversion rate estimation model 220 is obtained. The historical predicted conversion rates which are computed multiple times within the historical time period may be averaged to obtain the historical predicted conversion rate within the target historical time period. Compared to continuously accumulating conversion rate information in the historical time after the distribution of the recommended content item, the historical conversion rate is considered within the historical time period to capture a newer conversion situation better.

The coefficient determination module 510 determines a cost adjustment coefficient for the recommended content item 142 based on a ratio between the target predicted conversion rate and the historical predicted conversion rate. In some embodiments, in accordance with a determination that the ratio indicates the target predicted conversion rate exceeding the historical predicted conversion rate, the cost adjustment coefficient is increased by a first value. In some embodiments, in accordance with a determination that the ratio indicates the target predicted conversion rate being below the historical predicted conversion rate, the cost adjustment coefficient is decreased by a second value. In some embodiments, the first value and/or the second value may be computed based on a specific ratio between the target predicted conversion rate and the historical predicted conversion rate.

The following is an example computation method of cost adjustment coefficient:

$$perturb\_coef = 1 + perturb\_ratio * ( \frac{full\_cvr}{avg\_full \_cvr} - 1 ) \qquad ( 1 )$$

where perturb_coef represents the cost adjustment coefficient, perturb_ratio represents a perturbation weight, which may be a predetermined value; full_cvr represents the target predicted conversion rate; and avg_full_cvr represents the historical predicted conversion rate.

According to Equation (1), if full_cvr exceeds avg_full_cvr, perturb_coef increases by a certain amount and is greater than 1, while if full_cvr is below avg_full_cvr, perturb_coef increases by a certain amount and is less than 1. In some embodiments, an upper limit and/or a lower limit of the cost adjustment coefficient may also be set. If the cost adjustment coefficient determined based on the target predicted conversion rate and the historical predicted conversion rate exceeds the predetermined upper limit, the cost adjustment coefficient may be directly determined as the predetermined upper limit. If the cost adjustment coefficient determined based on the target predicted conversion rate and the historical predicted conversion rate is lower than the predetermined lower limit, the cost adjustment coefficient may be directly determined as the predetermined lower limit, which may be represented by equation (2), for example:

perturb_coef_clip=max(min(perturb_coef,upper_bound),lower_bound) (2)

where perturb_coef_clip represents the cost adjustment coefficient determined under the upper and lower limit constraints; perturb_coef represents the cost adjustment coefficient determined based on the target predicted conversion rate and the historical predicted conversion rate; upper_bound represents the predetermined upper limit; and lower_bound represents the predetermined lower limit.

In the strategy maker 230, the cost adjustment module 520 is configured to adjust, based on the cost adjustment coefficient 512, cost data for the recommended content item 142, to obtain adjusted cost data 522. As mentioned above, the cost data for the recommended content item 142 may include bidding for the recommended content item 142. The cost adjustment coefficient 512 may be used to determine whether to increase or decrease the current bidding, which may be represented as:

perturb_real_bid=real_bid*perturb_coef_clip (3)

where real_bid represents the current cost data of the recommended content item 142, and perturb_real_bid represents the adjusted cost data. According to the aforementioned Equations (1) to (3), if it is observed that the conversion rate of the target resource caused by the audience group is continuously increasing, the cost data may be increased appropriately, and vice versa, the cost data may be decreased.

The strategy formulation module 530 is configured to determine a distribution strategy 232 based on the adjusted cost data 522. The distribution strategy 232 may indicate how the recommended content item 142 related to the target resource is distributed among the target audience group.

On the premise of accurate evaluation of the conversion rate, preferences of the audience group for resources may be determined effectively, thereby formulating better distribution strategies to promote the conversion after the audience group receiving recommended content items and optimize content recommendation effect.

In some embodiments, the strategy maker 230 may dynamically adjust the distribution strategy of the recommended content item by perturbing the cost data, to optimize recommendation effect. In addition, in the strategy formulation process, the historical conversion situation may also be considered through a method of sliding average accumulation to achieve dynamic adjustment of the cost perturbation coefficient.

In addition to the cost data for adjusting the recommended content item, the target predicted conversion rate of the audience group for resources determined at the resource level may also be applied to other aspects related to resources and/or the recommended content items of resources. For example, in some embodiments, a conventional conversion rate evaluation model may be further used to determine the predicted conversion rate of the target audience group at the recommended content item level, and the predicted conversion rates of both levels may be combined to evaluate the predicted conversion situation of the target audience group better, and further influence the designation of subsequent content distribution strategies based on the conversion. The embodiments of the present disclosure do not limit the specific application of the target predicted conversion rate.

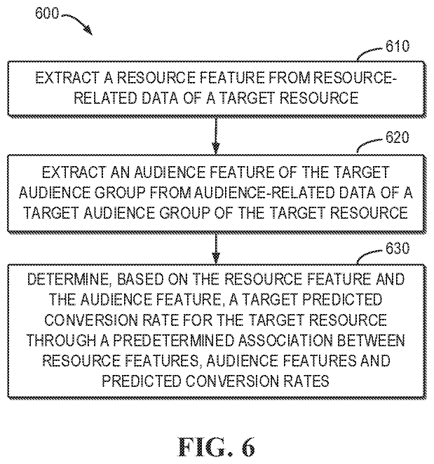

FIG. 6 illustrates a flowchart of a conversion evaluation process 600 according to some embodiments of the present disclosure. The process 600 may be implemented at content management system 120.

At block 610, the content management system 120 extracts a resource feature from resource-related data of a target resource.

At block 620, the content management system 120 extracts an audience feature of a target audience group from audience-related data of the target audience group of the target resource. The target audience group is to be distributed with a recommended content item related to the target resource.

At block 630, the content management system 120 determines, based on the resource feature and the audience feature, a target predicted conversion rate for the target resource through a predetermined association between resource features, audience features and predicted conversion rates. The target predicted conversion rate indicates a predicted probability of the target audience group performing a conversion for the target resource.

In some embodiments, the process 600 further comprises determining, based on the target predicted conversion rate, a distribution strategy of the recommended content item related to the target resource among the target audience group.

In some embodiments, determining the distribution strategy comprises: determining a cost adjustment coefficient based on the target predicted conversion rate; adjusting, based on the cost adjustment coefficient, cost data for the recommended content item; and determining the distribution strategy based on the adjusted cost data.

In some embodiments, determining the cost adjustment coefficient comprises: determining a historical predicted conversion rate for the target resource, the historical predicted conversion rate indicating a predicted probability of a historical audience group of the target resource performing a conversion for the target resource, the historical audience group being provided with the recommended content item related to the target resource within a historical time period; and determining the cost adjustment coefficient based on a ratio between the target predicted conversion rate and the historical predicted conversion rate.

In some embodiments, determining the cost adjustment coefficient based on the ratio comprises: in accordance with a determination that the ratio indicates the target predicted conversion rate exceeding the historical predicted conversion rate, increasing the cost adjustment coefficient by a first value; and in accordance with a determination that the ratio indicates the target predicted conversion rate being below the historical predicted conversion rate, decreasing the cost adjustment coefficient by a second value.

In some embodiments, determining the target predicted conversion rate comprises: determining a feature crossing result of the resource feature and the audience feature; and determining a predicted conversion rate for the target resource based on the feature crossing result.

In some embodiments, the predetermined association between resource features, audience features and predicted conversion rates is represented as a conversion rate estimation model, and the conversion rate estimation model is trained based at least on: a positive training sample, comprising a resource feature of a sample resource and an audience feature of a first sample audience group for the sample resource, the first sample audience group being distributed with a sample recommended content item related to the sample resource and labelled as having performed a conversion for the sample resource; and a negative training sample, comprising the resource feature of the sample resource and an audience feature of a second sample audience group that is randomly selected from an audience group set of the sample resource.

In some embodiments, the conversion rate estimation model is further trained based on: an event label of the positive training sample, the event label indicating an event type of the conversion of the first sample audience group, and wherein a training target of the conversion rate estimation model is configured to update parameter values of the conversion rate estimation model based at least on the event type.

In some embodiments, the process 600 further comprises: obtaining the resource-related data and the audience-related data based on authorization of a supplier of the target resource and the target audience group.

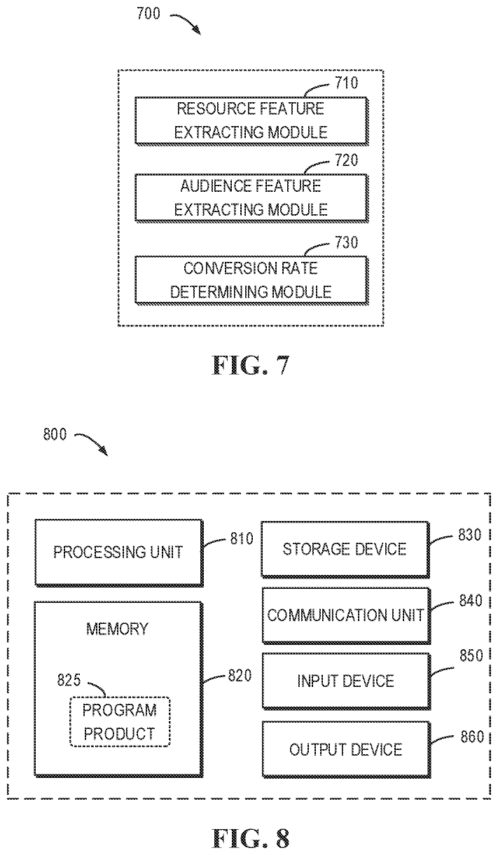

FIG. 7 illustrates a block diagram of an apparatus 700 for conversion evaluation according to some embodiments of the present disclosure. The apparatus 700 may be implemented or included in the content management system 120. Each module/component in the apparatus 700 may be implemented by hardware, software, firmware, or any combination thereof.

As shown in the figure, the apparatus 700 comprises a resource feature extracting module configured to extract a resource feature from resource-related data of a target resource. The apparatus 700 further comprises an audience feature extracting module configured to extract an audience feature of a target audience group from audience-related data of the target audience group of the target resource, the target audience group being to be distributed with a recommended content item related to the target resource. The apparatus 700 further comprises a conversion rate determining module configured to determine, based on the resource feature and the audience feature, a target predicted conversion rate for the target resource through a predetermined association between resource features, audience features and predicted conversion rates, the target predicted conversion rate indicating a predicted probability of the target audience group performing a conversion for the target resource.

In some embodiments, although not shown in the figure, the apparatus 700 further comprises: a distribution strategy determining module configured to determine, based on the target predicted conversion rate, a distribution strategy of the recommended content item related to the target resource among the target audience group.

In some embodiments, the distribution strategy demining module comprises: a coefficient determining module configured to determine a cost adjustment coefficient based on the target predicted conversion rate; a cost adjusting module configured to adjust, based on the cost adjustment coefficient, cost data for the recommended content item; and a cost-based strategy determining module configured to determine the distribution strategy based on the adjusted cost data.

In some embodiments, the coefficient determining module comprises: a historical conversion rate determining module configured to determine a historical predicted conversion rate for the target resource, the historical predicted conversion rate indicating a predicted probability of a historical audience group of the target resource performing a conversion for the target resource, the historical audience group being provided with the recommended content item related to the target resource within a historical time period; and a rate-based coefficient determining module configured to determine the cost adjustment coefficient based on a ratio between the target predicted conversion rate and the historical predicted conversion rate.

In some embodiments, the rate-based coefficient determining module comprises: a coefficient increasing module configured to, in accordance with a determination that the ratio indicates the target predicted conversion rate exceeding the historical predicted conversion rate, increase the cost adjustment coefficient by a first value; and a coefficient decreasing module configured to, in accordance with a determination that the ratio indicates the target predicted conversion rate being below the historical predicted conversion rate, decrease the cost adjustment coefficient by a second value.

In some embodiments, the conversion rate determining module comprises: a feature crossing module configured to determine a feature crossing result of the resource feature and the audience feature; and a feature cross-based conversion rate determining module configured to determine a predicted conversion rate for the target resource based on the feature crossing result.

In some embodiments, the predetermined association between resource features, audience features and predicted conversion rates is represented as a conversion rate estimation model, and the conversion rate estimation model is trained based at least on: a positive training sample, comprising a resource feature of a sample resource and an audience feature of a first sample audience group for the sample resource, the first sample audience group being distributed with a sample recommended content item related to the sample resource and labelled as having performed a conversion for the sample resource; and a negative training sample, comprising the resource feature of the sample resource and an audience feature of a second sample audience group that is randomly selected from an audience group set of the sample resource.

In some embodiments, the conversion rate estimation model is further trained based on: an event label of the positive training sample, the event label indicating an event type of the conversion of the first sample audience group. In some embodiments, a training target of the conversion rate estimation model is configured to update parameter values of the conversion rate estimation model based at least on the event type.

In some embodiments, the apparatus 700 further comprises: a data obtaining module configured to obtain the resource-related data and the audience-related data based on authorization of a supplier of the target resource and the target audience group.

FIG. 8 illustrates a block diagram of an electronic device 800 in which one or more embodiments of the present disclosure may be implemented. It would be appreciated that the electronic device 800 shown in FIG. 8 is only an example and should not constitute any restriction on the function and scope of the embodiments described herein. The electronic device 800 shown in FIG. 8 may be used to implement the content management system 120.

As shown in FIG. 8, the electronic device 800 is in the form of a general computing device. The components of the electronic device 800 may include, but are not limited to, one or more processors or processing units 810, a memory 820, a storage device 830, one or more communication units 840, one or more input devices 850, and one or more output devices 860. The processing unit 810 may be an actual or virtual processor and may execute various processes according to the programs stored in the memory 820. In a multiprocessor system, multiple processing units execute computer executable instructions in parallel to improve the parallel processing capability of the electronic device 800.

The electronic device 800 typically includes a variety of computer storage medium. Such medium may be any available medium that is accessible to the electronic device 800, including but not limited to volatile and non-volatile medium, removable and non-removable medium. The memory 820 may be volatile memory (for example, a register, cache, a random access memory (RAM)), a non-volatile memory (for example, a read-only memory (ROM), an electrically erasable programmable read-only memory (EEPROM), a flash memory) or any combination thereof. The storage device 830 may be any removable or non-removable medium, and may include a machine-readable medium, such as a flash drive, a disk, or any other medium, which may be used to store information and/or data (such as training data for training) and may be accessed within the electronic device 800.

The electronic device 800 may further include additional removable/non-removable, volatile/non-volatile storage medium. Although not shown in FIG. 8, a disk driver for reading from or writing to a removable, non-volatile disk (such as a “floppy disk”), and an optical disk driver for reading from or writing to a removable, non-volatile optical disk may be provided. In these cases, each driver may be connected to the bus (not shown) by one or more data medium interfaces. The memory 820 may include a computer program product 825, which has one or more program modules configured to perform various methods or acts of various embodiments of the present disclosure.

The communication unit 840 communicates with a further computing device through the communication medium. In addition, functions of components in the electronic device 800 may be implemented by a single computing cluster or multiple computing machines, which may communicate through a communication connection. Therefore, the electronic device 800 may be operated in a networking environment using a logical connection with one or more other servers, a network personal computer (PC), or another network node.

The input device 850 may be one or more input devices, such as a mouse, a keyboard, a trackball, etc. The output device 860 may be one or more output devices, such as a display, a speaker, a printer, etc. The electronic device 800 may also communicate with one or more external devices (not shown) through the communication unit 840 as required. The external device, such as a storage device, a display device, etc., communicate with one or more devices that enable users to interact with the electronic device 800, or communicate with any device (for example, a network card, a modem, etc.) that makes the electronic device 800 communicate with one or more other computing devices. Such communication may be executed via an input/output (I/O) interface (not shown).

According to example implementation of the present disclosure, a computer-readable storage medium is provided, on which a computer-executable instruction or computer program is stored, wherein the computer-executable instructions or the computer program is executed by the processor to implement the method described above. According to example implementation of the present disclosure, a computer program product is also provided. The computer program product is physically stored on a non-transient computer-readable medium and includes computer-executable instructions, which are executed by the processor to implement the method described above.

Various aspects of the present disclosure are described herein with reference to the flow chart and/or the block diagram of the method, the apparatus, the device and the computer program product implemented in accordance with the present disclosure. It would be appreciated that each block of the flowchart and/or the block diagram and the combination of each block in the flowchart and/or the block diagram may be implemented by computer-readable program instructions.

These computer-readable program instructions may be provided to the processing units of general-purpose computers, special computers or other programmable data processing devices to produce a machine that generates a device to implement the functions/acts specified in one or more blocks in the flow chart and/or the block diagram when these instructions are executed through the processing units of the computer or other programmable data processing devices. These computer-readable program instructions may also be stored in a computer-readable storage medium. These instructions enable a computer, a programmable data processing device and/or other devices to work in a specific way. Therefore, the computer-readable medium containing the instructions includes a product, which includes instructions to implement various aspects of the functions/acts specified in one or more blocks in the flowchart and/or the block diagram.

The computer-readable program instructions may be loaded onto a computer, other programmable data processing apparatus, or other devices, so that a series of operational steps may be performed on a computer, other programmable data processing apparatus, or other devices, to generate a computer-implemented process, such that the instructions which execute on a computer, other programmable data processing apparatus, or other devices implement the functions/acts specified in one or more blocks in the flowchart and/or the block diagram.

The flowchart and the block diagram in the drawings show the possible architecture, functions and operations of the system, the method and the computer program product implemented in accordance with the present disclosure. In this regard, each block in the flowchart or the block diagram may represent a section of a module, a program segment or instructions, which contains one or more executable instructions for implementing the specified logic function. In some alternative implementations, the functions marked in the block may also occur in a different order from those marked in the drawings. For example, two consecutive blocks may actually be executed in parallel, and sometimes may also be executed in a reverse order, depending on the function involved. It should also be noted that each block in the block diagram and/or the flowchart, and combinations of blocks in the block diagram and/or the flowchart, may be implemented by a dedicated hardware-based system that performs the specified functions or acts, or by the combination of dedicated hardware and computer instructions.

Each implementation of the present disclosure has been described above. The above description is exemplary, not exhaustive, and is not limited to the disclosed implementations. Without departing from the scope and spirit of the described implementations, many modifications and changes are obvious to ordinary skill in the art. The selection of terms used in this article aims to best explain the principles, practical application or improvement of technology in the market of each implementation, or to enable other ordinary skill in the art to understand the various embodiments disclosed herein.

1. A method of conversion evaluation, comprising:
extracting a resource feature from resource-related data of a target resource;
extracting an audience feature of the target audience group from audience-related data of a target audience group of the target resource, the target audience group being to be distributed with a recommended content item related to the target resource; and
determining, based on the resource feature and the audience feature, a target predicted conversion rate for the target resource through a predetermined association between resource features, audience features and predicted conversion rates, the target predicted conversion rate indicating a predicted probability of the target audience group performing a conversion for the target resource.

2. The method of claim 1, further comprising:
determining, based on the target predicted conversion rate, a distribution strategy of the recommended content item related to the target resource among the target audience group.

3. The method of claim 2, wherein determining the distribution strategy comprises:
determining a cost adjustment coefficient based on the target predicted conversion rate;
adjusting, based on the cost adjustment coefficient, cost data for the recommended content item; and
determining the distribution strategy based on the adjusted cost data.

4. The method of claim 3, wherein determining the cost adjustment coefficient comprises:
determining a historical predicted conversion rate for the target resource, the historical predicted conversion rate indicating a predicted probability of a historical audience group of the target resource performing a conversion for the target resource, the historical audience group being provided with the recommended content item related to the target resource within a historical time period; and
determining the cost adjustment coefficient based on a ratio between the target predicted conversion rate and the historical predicted conversion rate.

5. The method of claim 4, wherein determining the cost adjustment coefficient based on the ratio comprises:
in accordance with a determination that the ratio indicates the target predicted conversion rate exceeding the historical predicted conversion rate, increasing the cost adjustment coefficient by a first value; and
in accordance with a determination that the ratio indicates the target predicted conversion rate being below the historical predicted conversion rate, decreasing the cost adjustment coefficient by a second value.

6. The method of claim 1, wherein determining the target predicted conversion rate comprises:
determining a feature crossing result of the resource feature and the audience feature; and
determining a predicted conversion rate for the target resource based on the feature crossing result.

7. The method of claim 1, wherein the predetermined association between resource features, audience features and predicted conversion rates is represented as a conversion rate estimation model, and the conversion rate estimation model is trained based at least on:
a positive training sample, comprising a resource feature of a sample resource and an audience feature of a first sample audience group for the sample resource, the first sample audience group being distributed with a sample recommended content item related to the sample resource and labelled as having performed a conversion for the sample resource; and
a negative training sample, comprising the resource feature of the sample resource and an audience feature of a second sample audience group that is randomly selected from an audience group set of the sample resource.

8. The method of claim 7, wherein the conversion rate estimation model is further trained based on: an event label of the positive training sample, the event label indicating an event type of the conversion of the first sample audience group, and
wherein a training target of the conversion rate estimation model is configured to update parameter values of the conversion rate estimation model based at least on the event type.

9. The method of claim 1, further comprising:
obtaining the resource-related data and the audience-related data based on authorization of a supplier of the target resource and the target audience group.

10. An electronic device, comprising:
at least one processing unit; and
at least one memory coupled to the at least one processing unit and storing instructions executable by the at least one processing unit, the instructions, when executed by the at least one processing unit, causing the device to perform a method of conversion evaluation, the method comprising following acts of:
extracting a resource feature from resource-related data of a target resource;
extracting an audience feature of the target audience group from audience-related data of a target audience group of the target resource, the target audience group being to be distributed with a recommended content item related to the target resource; and
determining, based on the resource feature and the audience feature, a target predicted conversion rate for the target resource through a predetermined association between resource features, audience features and predicted conversion rates, the target predicted conversion rate indicating a predicted probability of the target audience group performing a conversion for the target resource.

11. The device of claim 10, wherein the acts further comprise:
determining, based on the target predicted conversion rate, a distribution strategy of the recommended content item related to the target resource among the target audience group.

12. The device of claim 11, wherein determining the distribution strategy comprises:
determining a cost adjustment coefficient based on the target predicted conversion rate;
adjusting, based on the cost adjustment coefficient, cost data for the recommended content item; and
determining the distribution strategy based on the adjusted cost data.

13. The device of claim 12, wherein determining the cost adjustment coefficient comprises:
determining a historical predicted conversion rate for the target resource, the historical predicted conversion rate indicating a predicted probability of a historical audience group of the target resource performing a conversion for the target resource, the historical audience group being provided with the recommended content item related to the target resource within a historical time period; and
determining the cost adjustment coefficient based on a ratio between the target predicted conversion rate and the historical predicted conversion rate.

14. The device of claim 13, wherein determining the cost adjustment coefficient based on the ratio comprises:
in accordance with a determination that the ratio indicates the target predicted conversion rate exceeding the historical predicted conversion rate, increasing the cost adjustment coefficient by a first value; and
in accordance with a determination that the ratio indicates the target predicted conversion rate being below the historical predicted conversion rate, decreasing the cost adjustment coefficient by a second value.

15. The device of claim 10, wherein determining the target predicted conversion rate comprises:
determining a feature crossing result of the resource feature and the audience feature; and
determining a predicted conversion rate for the target resource based on the feature crossing result.

16. The device of claim 10, wherein the predetermined association between resource features, audience features and predicted conversion rates is represented as a conversion rate estimation model, and the conversion rate estimation model is trained based at least on:
a positive training sample, comprising a resource feature of a sample resource and an audience feature of a first sample audience group for the sample resource, the first sample audience group being distributed with a sample recommended content item related to the sample resource and labelled as having performed a conversion for the sample resource; and
a negative training sample, comprising the resource feature of the sample resource and an audience feature of a second sample audience group that is randomly selected from an audience group set of the sample resource.

17. The device of claim 16, wherein the conversion rate estimation model is further trained based on: an event label of the positive training sample, the event label indicating an event type of the conversion of the first sample audience group, and
wherein a training target of the conversion rate estimation model is configured to update parameter values of the conversion rate estimation model based at least on the event type.

18. The device of claim 10, wherein the acts further comprise:
obtaining the resource-related data and the audience-related data based on authorization of a supplier of the target resource and the target audience group.

19. A computer-readable storage medium having a computer program stored thereon which, when executed by a processor, performs a method of conversion evaluation, the method comprising following acts of:
extracting a resource feature from resource-related data of a target resource;
extracting an audience feature of the target audience group from audience-related data of a target audience group of the target resource, the target audience group being to be distributed with a recommended content item related to the target resource; and
determining, based on the resource feature and the audience feature, a target predicted conversion rate for the target resource through a predetermined association between resource features, audience features and predicted conversion rates, the target predicted conversion rate indicating a predicted probability of the target audience group performing a conversion for the target resource.

20. The storage medium of claim 19, wherein the acts further comprise:
determining, based on the target predicted conversion rate, a distribution strategy of the recommended content item related to the target resource among the target audience group.
